(19) United States
(12) Patent Application Publication
(10) Pub. No.: US 2011/0189329 A1
(43) Pub. Date: Aug. 4, 2011

(54) Ultra-Compliant Nanoimprint Lithography Template

(75) Inventors: Michael N. Miller, Austin, TX (US); Weijun Liu, Cedar Park, TX (US); Frank Y. Xu, Round Rock, TX (US)

(73) Assignee: MOLECULAR IMPRINTS, INC., Austin, TX (US)

(21) Appl. No.: 13/017,781

(22) Filed: Jan. 31, 2011

Related U.S. Application Data
(60) Provisional application No. 61/299,805, filed on Jan. 29, 2010.
(60) Provisional application No. 61/300,537, filed on Feb. 2, 2010.

(51) Int. Cl. B29C 59/02; C08J 7/04; B82Y 30/00

(52) U.S. Cl. 425/385; 427/510; 977/902

(57) ABSTRACT

An ultra-compliant nanoimprint lithography template having a backing layer and a nanopatterned layer adhered to the backing layer. The nanopatterned layer includes nanoscale features formed by solidifying a polymerizable material in contact with a mold. The polymerizable material includes a fluoroelastomer and a photoinitiator. The backing layer has a higher elastic modulus than the nanopatterned layer. The ultra-compliant nanoimprint lithography template can be used to form multiple high fidelity imprints.

### CROSS-REFERENCE TO RELATED APPLICATIONS

This application claims priority to U.S. Application Ser. No. 61/299,805 filed on Jan. 29, 2010 and U.S. Application Ser. No. 61/300,537, filed on Feb. 2, 2010, each of which is incorporated by reference herein in its entirety.

### TECHNICAL FIELD

The present invention relates to ultra-compliant templates for nanoimprint lithography.

### BACKGROUND

Nano-fabrication includes the fabrication of very small structures that have features on the order of 100 nanometers or smaller. One application in which nano-fabrication has had a sizeable impact is in the processing of integrated circuits. The semiconductor processing industry continues to strive for larger production yields while increasing the circuits per unit area formed on a substrate, therefore nano-fabrication becomes increasingly important. Nano-fabrication provides greater process control while allowing continued reduction of the minimum feature dimensions of the structures formed. Other areas of development in which nano-fabrication has been employed include biotechnology, optical technology, mechanical systems, and the like.

An exemplary nano-fabrication technique in use today is commonly referred to as imprint lithography. Exemplary imprint lithography processes are described in detail in numerous publications, such as U.S. Patent Application Publication No. 2004/0065976, U.S. Patent Application Publication No. 2004/0065252, and U.S. Pat. No. 6,936,194, all of which are hereby incorporated by reference herein.

An imprint lithography technique disclosed in each of the aforementioned U.S. patent application publications and patent includes formation of a relief pattern in a formable (polymerizable) layer and transferring a pattern corresponding to the relief pattern into an underlying substrate. The substrate may be coupled to a motion stage to obtain a desired positioning to facilitate the patterning process. The patterning process uses a template spaced apart from the substrate and the formable liquid applied between the template and the substrate. The formable liquid is solidified to form a rigid layer that has a pattern conforming to a shape of the surface of the template that contacts the formable liquid. After solidification, the template is separated from the rigid layer such that the template and the substrate are spaced apart. This technique may be applied to create multiple copies, or daughter templates, of a single original, or “master” template.

Substrate surface defects and particles positioned between the substrate and the template can limit the effectiveness of pattern transfer in nanoimprinting processes. FIG. 1 illustrates damage 2 of a mold or template 18 formed from a rigid material and exclusion of polymerizable material 34 from volume 4 when a particle 6 is positioned between the template and the surface of the substrate 12. In some cases, lack of contact between the template and the substrate during imprinting (e.g., caused by surface defects on the substrate) may yield excluded regions in the imprint and/or regions of thick residual layer. The excluded distance 5 can be measured as a distance from particle 6 to the polymerizable material 34. Some surface defects may result in imperfections that are repeated across multiple imprint cycles.

As illustrated in FIG. 1, templates formed from hard or rigid materials (e.g., glass or silicon) may be unable to conform to small (e.g., sub-micron) particles, due at least in part to the high elastic modulus of the template material and the spatial conformality related to modulus and thickness of the template. In some cases, the presence of a particle 6 (e.g., a sub-micron particle) can cause printing volume exclusions 4 on the order of cubic millimeters. In other cases, a substrate with a high surface roughness (e.g., a high spatial frequency of low-amplitude defects) can create filling problems associated with conforming difficulty for a nanoimprint template 18.

Various methods have been described to generate “soft templates” or nanoimprint templates that employ a single soft material to conform to particles on a substrate or to address surface topography of a substrate. In some cases, use of a single layer of an elastomeric or thin plastic material with a low elastic modulus (e.g., poly(dimethylsiloxane) (PDMS) with an elastic modulus of about 1 MPa) as a template can result in roof collapse, lateral collapse, and/or rounding of features in the resulting patterned layer by surface tension. Roof collapse can occur when the patterned surface of the template has a wide and shallow relief pattern. Lateral collapse can occur when closely spaced, narrow features collapse laterally during imprinting due to the low modulus of the patterned surface of the template. Surface tension-related deformation can occur in elastomeric patterned layers and is related to the rounding of sharp corners due to surface tension after the patterned surface is released from the template.

Other methods include the use of two-layer templates and low elastic modulus single-use polymeric templates. These methods, however, can also yield patterned layer subject roof collapse, lateral collapse, and/or surface tension related deformation, and can sometimes require multi-step fabrication processes and temperature-controlled molding and/or demolding processes. For example, use of a single polymeric material as a disposable nanoimprint template may require two imprint steps for each imprinted substrate, including forming the template and imprinting on the substrate. Temperature-controlled molding and/or demolding may be used, for example, when curing occurs by methods other than ultraviolet irradiation.

Even with the use of a thin plastic template (elastic modulus>1 GPa) or a thin glass template (elastic modulus>70 GPa) separately or as part of a multilayer template, a desired level of conformality may not be achieved over a substrate with severe topography. Severe topography, such as an elevation change of hundreds of nanometers over a distance of hundreds of microns, has been observed for substrates such as polycrystalline and ultrathin silicon solar substrates. While softer elastomeric materials (e.g., PDMS, with an elastic modulus between about 100 kPa and about 3 MPa) may be able to achieve surface contact with a rough substrate, the resulting patterned layer may demonstrate feature distortion and/or pattern fidelity limits.

### SUMMARY

In one aspect, a nanoimprint lithography template includes a backing layer and a nanopatterned layer adhered to the backing layer, wherein the nanopatterned layer comprises nanoscale features formed by solidifying a polymerizable material in contact with a mold. The polymerizable material includes a fluoroelastomer and a photoinitiator. The backing layer has a higher elastic modulus than the nanopatterned layer.

In another aspect, a nanoimprint lithography template includes a backing layer and a nanopatterned layer adhered to the backing layer. The nanopatterned layer includes nanoscale features formed by solidifying a polymerizable material in contact with a nanopatterned mold. A viscosity of the polymerizable material at room temperature is less than about 200 cP or less than about 150 cP, and the nanoimprint lithography template is operable to form a patterned layer from an imprint resist on a substrate, the substrate having a micron-scale defect, such that an unpatterned area proximate the defect is less than a projected area of the defect on the substrate.

In another aspect, a nanoimprint lithography mold assembly includes a substrate, a polymerizable material disposed on the substrate, and a nanoimprint lithography template in contact with the polymerizable material. The nanoimprint lithography template includes a backing layer and a nanopatterned layer adhered to the backing layer. The nanopatterned layer includes nanoscale features formed by solidifying a polymerizable material comprising a fluoroelastomer and a photoinitiator in contact with a nanopatterned mold. The polymerizable material has a viscosity at room temperature of less than about 200 cP or less than about 150 cP.

In another aspect, fabricating a nanoimprint lithography template includes selecting a backing layer, disposing a polymerizable material on the backing layer, and contacting the polymerizable material with a nanopatterned mold. The polymerizable material includes a fluoroelastomer and a photoinitiator, and has a viscosity at room temperature of less than about 200 cP or less than about 150 cP. The polymerizable material is exposed to ultraviolet radiation to solidify the polymerizable material, thereby forming a solidified nanopatterned layer in contact with the nanopatterned mold and adhered to the backing layer. The nanopatterned mold is separated from the solidified nanopatterned layer adhered to the substrate. An elastic modulus of the solidified nanopatterned layer is greater than an elastic modulus of the backing layer.

In some cases, fabricating a nanoimprint lithography template can also include forming an adhesion layer on the backing layer before disposing the polymerizable material on the backing layer. Disposing the polymerizable material on the backing layer can include dispensing drops of the polymerizable material on the backing layer. In some cases, after separating the nanopatterned mold from the solidified nanopatterned layer, the solidified nanopatterned layer is contacted with an imprint resist on a substrate with a micron-scale defect, and the imprint resist is solidified to yield a solidified imprint resist having an unpatterned area in the solidified imprint resist proximate the defect that is less than a projected area of the defect on the substrate. In certain cases, after separating the nanopatterned mold from the solidified nanopatterned layer, the solidified nanopatterned layer is contacted with an imprint resist on a substrate having 30 μm tall, 1 mm wide ridges and surface roughness up to 600 nm over a length of 100 μm, and the imprint resist is solidified to yield a solidified imprint that conforms to the substrate over at least 75% of the surface area of the solidified nanopatterned layer.

In certain implementations, the fluoroelastomer includes a fluorinated ether-based acrylate (e.g., a fluorinated ether-based acrylate or methacrylate). The fluorinated ether-based acrylate can include a fluorinated ether-based urethane dimethacrylate, a fluorinated ether-based diacrylate, a fluorinated ether-based mono-acrylate, or a combination thereof. In some cases, an elastic modulus of the fluoroelastomer is between about 3 MPa and about 50 MPa or between about 5 MPa and about 25 MPa. A viscosity of the polymerizable material at room temperature is less than about 200 cP or less than about 150 cP. The polymerizable material may be ink-jettable.

In some cases, there is an adhesion layer between the backing layer and the nanopatterned layer. Solidifying the polymerizable material may consist of irradiating the polymerizable material with ultraviolet radiation. The porosity (or gas permeability) of the nanopatterned layer can be greater than a porosity (or gas permeability) of the backing layer. In some cases, the porosity (or gas permeability) of the nanopatterned layer is greater than a porosity (or gas permeability) of fused silica or of another plastic or non-fluorinated polymer.

In certain implementations, when the nanoimprint lithography template is used to replicate the nanopatterned layer in an imprint resist on a substrate, the substrate comprising 30 μm tall, 1 mm wide ridges and surface roughness up to 600 nm over a length of 100 μm, the nanoimprint lithography template yields an imprint that conforms to the substrate over at least 75% of the surface area of the template. In some cases, the template is operable to form a patterned layer in an imprint resist on a substrate with a micron-scale defect, such that the unpatterned area proximate the defect is less than a projected area of the defect on the substrate.

In some cases, the template is operable to form a patterned layer in an imprint resist on a substrate with a micron-scale defect, such that the unpatterned area proximate the defect is less than a projected area of the defect on the substrate. The nanoimprint lithography template can be used to form multiple imprints (e.g., over 100 imprints or over 200) with little or no loss or reduction of feature fidelity.

As described herein, ultra-compliant nanoimprint templates demonstrate longevity, feature fidelity, UV transparence, and are substantially conformable to surface topography, including surface defects and particles positioned between the substrate and the mold. Materials used to form the ultra-compliant templates can be dispensed as a droplet or series of droplets on an automated nanoimprint tool and processed at room temperature to allow for rapid production of compliant template replicas with low material usage and ease of processing.

Aspects and implementations described herein may be combined in ways other than described above. Other aspects, features, and advantages will be apparent from the following detailed description, the drawings, and the claims.

### BRIEF DESCRIPTION OF THE DRAWINGS

FIG. 1 illustrates damage to a rigid mold and an excluded volume associated with a particle positioned between a substrate and the mold.

FIG. 2 illustrates a simplified side view of a lithographic system.

FIG. 3 illustrates a simplified side view of the substrate shown in FIG. 2 having a patterned layer positioned thereon.

FIG. 4 depicts a single layer nanoimprint template.

FIG. 5 depicts a multilayer nanoimprint template.

FIG. 6 depicts a multilayer nanoimprint template.

FIG. 7 shows exclusion radius versus particle size calculated for a ultra-compliant nanoimprint template with an elastic modulus of about 70 GPa.

FIG. 8 shows exclusion radius versus particle size calculated for a ultra-compliant nanoimprint template with an elastic modulus of about 5 MPa.

FIG. 9 shows conformance of an imprint formed with a template including a fluoroelastomer on a rough substrate.

FIG. 10A shows conformance of a polymethyl methacrylate (PMMA) template on a rough substrate.

FIG. 10B shows a profilometer measurement of a portion of a substrate in FIG. 10A.

FIG. 10C is a profilometer measurement of a ridge from the surface of the substrate shown in FIG. 10B.

FIGS. 11A and 11B show cross-sectional scanning electron micrograph (SEM) images of the imprinted substrate from FIG. 9.

FIG. 12 shows an SEM image of an imprinted pattern over a 1 μm glass particle made by a nanoimprint lithography template having a fluoroelastomer layer.

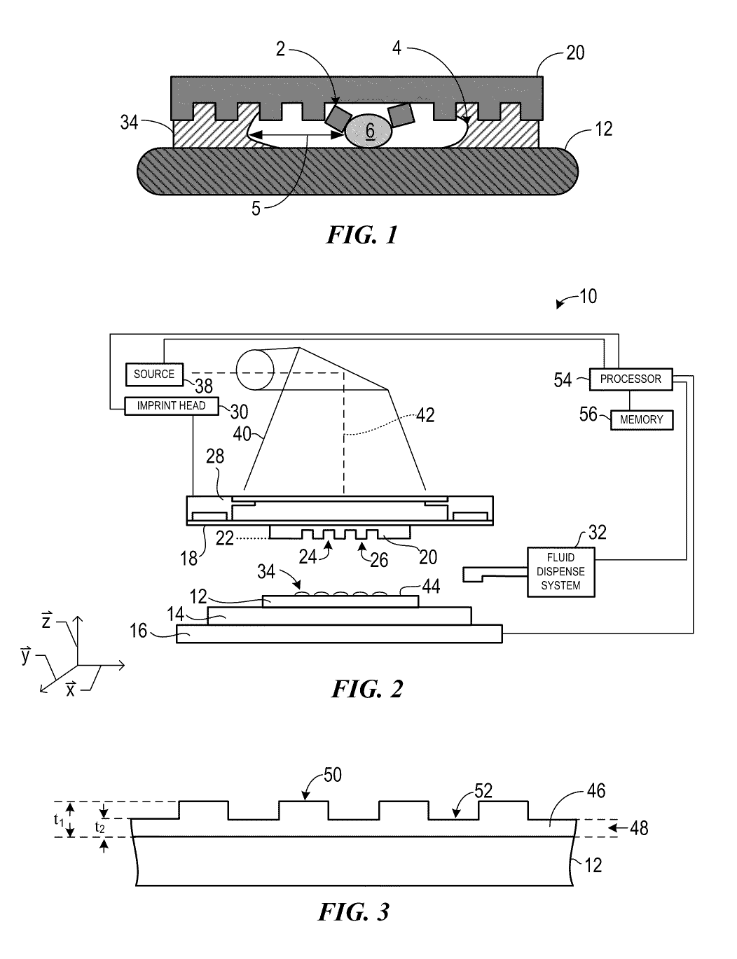

### DETAILED DESCRIPTION

Referring to FIG. 2, illustrated therein is a lithographic system 10 used to form a relief pattern on substrate 12. Substrate 12 may be coupled to substrate chuck 14. As illustrated, substrate chuck 14 is a vacuum chuck. Substrate chuck 14, however, may be any chuck including, but not limited to, vacuum, pin-type, groove-type, electromagnetic, and/or the like. Exemplary chucks are described in U.S. Pat. No. 6,873,087, which is hereby incorporated by reference herein.

Substrate 12 and substrate chuck 14 may be further supported by stage 16. Stage 16 may provide motion about the x-, y-, and z-axes. Stage 16, substrate 12, and substrate chuck 14 may also be positioned on a base (not shown).

Spaced-apart from substrate 12 is a template 18. Template 18 generally includes a rectangular or square mesa 20, with dimensions up to about 150 microns, and extending about 10 microns to about 50 microns, or about 15 microns to about 20 microns from a surface of the template towards substrate 12. A surface of mesa 20 may include patterning surface 22. In some cases, mesa 20 is referred to as mold 20. Template 18 and/or mold 20 may be formed from such materials including, but not limited to, fused silica, quartz, silicon, silicon nitride, organic polymers, siloxane polymers, borosilicate glass, fluorocarbon polymers, metal (e.g. chrome, tantalum), hardened sapphire, or the like, or a combination thereof. In some cases, template 18 and/or mold 20 is an ultra-compliant template as described herein. As illustrated, patterning surface 22 comprises features defined by a plurality of spaced-apart recesses 24 and/or protrusions 26, though embodiments are not limited to such configurations. Patterning surface 22 may define any original pattern that forms the basis of a pattern to be formed on substrate 12.

Template 18 may be coupled to chuck 28. Chuck 28 may be configured as, but not limited to, vacuum, pin-type, groove-type, electromagnetic, and/or other similar chuck types. Exemplary chucks are further described in U.S. Pat. No. 6,873,087. Further, chuck 28 may be coupled to imprint head 30 such that chuck 28 and/or imprint head 30 may be configured to facilitate movement of template 18.

System 10 may further comprise a fluid dispense system 32. Fluid dispense system 32 may be used to deposit polymerizable material 34 on substrate 12. Polymerizable material 34 may be positioned upon substrate 12 using techniques such as drop dispense, spin-coating, dip coating, chemical vapor deposition (CVD), physical vapor deposition (PVD), thin film deposition, thick film deposition, and/or the like. Polymerizable material 34 may be disposed upon substrate 12 before and/or after a desired volume is defined between mold 20 and substrate 12 depending on design considerations. Polymerizable material 34 may comprise a monomer as described in U.S. Pat. No. 7,157,036 and U.S. Patent Application Publication No. 2005/0187339, all of which are incorporated by reference herein.

Referring to FIGS. 2 and 3, system 10 may further include an energy source 38 coupled to direct energy 40 along path 42. Imprint head 30 and stage 16 may be configured to position template 18 and substrate 12 in superimposition with path 42. System 10 may be regulated by a processor 54 in communication with stage 16, imprint head 30, fluid dispense system 32, and/or source 38, and may operate on a computer readable program stored in memory 56.

Either imprint head 30, stage 16, or both vary a distance between mold 20 and substrate 12 to define a desired volume therebetween that is filled by polymerizable material 34. For example, imprint head 30 may apply a force to template 18 such that mold 20 contacts polymerizable material 34. After the desired volume is filled with polymerizable material 34, source 38 produces energy 40, e.g., broadband ultraviolet radiation, causing polymerizable material 34 to solidify and/or cross-link conforming to shape of a surface 44 of substrate 12 and patterning surface 22, defining a patterned layer 46 on substrate 12. Patterned layer 46 may include a residual layer 48 and a plurality of features shown as protrusions 50 and recessions 52, with protrusions 50 having a thickness t1 and residual layer 48 having a thickness t2.

The above-described system and process may be further implemented in imprint lithography processes and systems referred to in U.S. Pat. Nos. 6,932,934; 7,077,992; 7,179,396; and 7,396,475, each of which is incorporated by reference herein.

In some embodiments, an ultra-compliant nanoimprint template is a single layer or multilayer template with patterned layer having a functional imprint material including a fluoroelastomer. The elastic modulus of suitable fluoroelastomer layers typically exceeds the elastic modulus of silicon-containing elastomers including, for example, SYLGARD 184 (a PDMS elastomer available from Dow Corning, Midland, Mich.), with an elastic modulus of about 1 MPa.

Suitable fluoroelastomer materials include fluorinated ether-based acrylates (e.g., fluorinated ether-based methacrylates), such as fluorinated ether-based urethane dimethacrylates (e.g., MD700 available from Solvay Solexis, Belgium), fluorinated ether-based diacrylates (e.g., 5110X available from Solvay Solexis), and fluorinated ether-based mono-acrylates (e.g., 7304 available from Solvay Solexis). The fluoroelastomers may be used separately or as a mixture of two or more fluoroelastomers. Fluoroelastomer materials may be combined with a photoinitiator (e.g., Darocur 1173 available from Ciba-Geigy, Switzerland) to facilitate UV curing. As used herein, fluoroelastomer materials are completely cured by UV irradiation. That is, further post-processing, such as heating, is not required to fabricate a patterned layer suitable for repeated imprints, for example, on substrates with high topography (i.e., rough surfaces). The fluoroelastomer materials may be non-silicon-containing.

In some cases, fluoroelastomer formulations described herein, as applied to a substrate, have a viscosity at room temperature of greater than about 1 cP, greater than about 5 cP, greater than about 10 cP, or greater than about 20 cP and less than about 200 cP, less than about 150 cP, or less than about 100 cP. A fluoroelastomer formulation can have a viscosity that allows ink-jetting of the fluoroelastomer formulation onto a substrate (e.g., at most about 100 cP or at most about 150 cP). The elastic modulus of a fluoroelastomer in a nanoimprint template may be at least about 3 MPa or at least about 5 MPa and less than about 100 MPa, less than about 50 MPa, or less than about 25 MPa. Example fluoroelastomer formulations suitable for fabricating fluoroelastomer layers in an ultra-compliant template are shown in Table I, along with an approximate range or value of elastic modulus for each formulation.

TABLE I
Fluoroelastomer formulations

| | CT1 | CT2 | CT3 |
|---|---|---|---|
| MD700 (g) | 97 | 77 | 57 |
| 5110X (g) | | | 40 |
| 7304 (g) | | 20 | |
| DAROCUR 1173 (g) | 3 | 3 | 3 |
| Elastic modulus (MPa) | 20-25 | 10-15 | ~5 |
| Viscosity at room | | | 138 |
| temperature (cP) | | | |

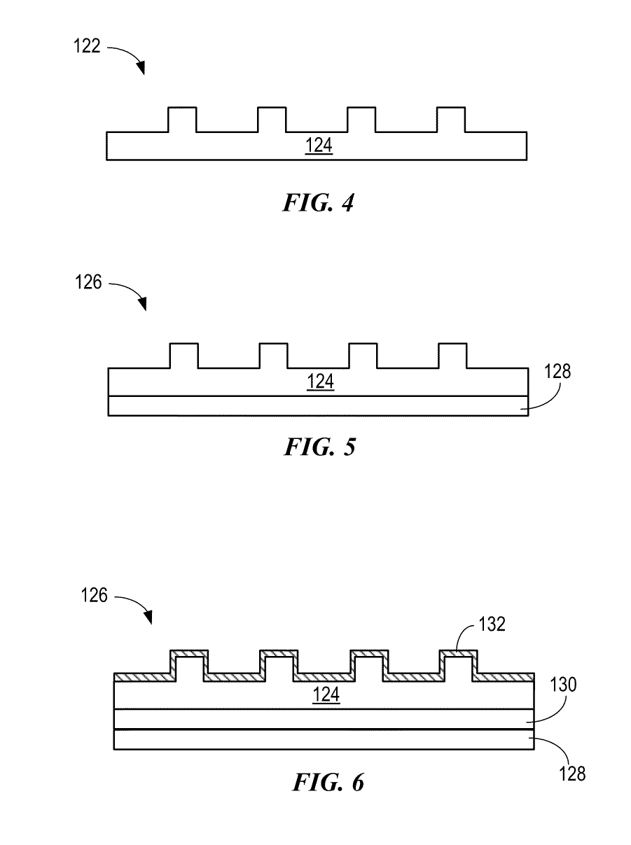

FIG. 4 shows single layer ultra-compliant nanoimprint template 122 with fluoroelastomer layer 124. Single layer ultra-compliant nanoimprint template 122 may be fabricated by applying fluoroelastomer material on a substrate. The fluoroelastomer may be applied on the substrate, for example, by ink-jetting or spin-coating the fluoroelastomer material or by dispensing droplets of the fluoroelastomer material on the substrate. The fluoroelastomer material is contacted (e.g., in a process described with respect to FIGS. 2 and 3) with a master template, and cured with UV radiation. After curing, template 122 may be peeled from the substrate. A thickness of template 122 can be selected by controlling a distance between the substrate and the master template during imprinting. Nanoimprint templates described herein can be used to nanopattern sub-100 nm features and maintain feature fidelity for multiple imprints. In some cases, an ultra-compliant nanoimprint template can be used to form 100 imprints, 200 imprints, 1000 imprints, or more without loss of feature fidelity.

FIG. 5 shows an example of multilayer ultra-compliant nanoimprint template 126 with backing layer 128 and fluoroelastomer layer 124. In some cases, backing layer 128 is selected for transparency to UV radiation. Backing layer 128 can include materials with an elastic modulus of less than about 3 GPa (e.g., polycarbonate and PMMA). In some cases, a thin layer of a material with a higher elastic modulus, such as glass, can be used as a backing layer. The thin layer may have a thickness, for example, of less than 300 μm. In an example, VF-45 drawn glass from Schott GmbH can be used as a backing layer. In some cases, backing layer 128 is treated prior to formation of fluoroelastomer layer 124. Treatment of backing layer 128 may include, for example, argon sputtering and/or oxygen plasma, ozone, or vacuum ultraviolet lamp exposure of the backing layer to enhance adhesion of fluoroelastomer layer 124 to the backing layer.

In some cases, multilayer ultra-compliant nanoimprint template 126 includes more than two layers. FIG. 6 shows an example of ultra-compliant nanoimprint template 126 with backing layer 128, adhesion layer 130, fluoroelastomer layer 124. In some cases, backing layer 128 is treated prior to formation of adhesion layer 130. Treatment of backing layer 128 may include, for example, argon sputtering and/or oxygen plasma, ozone, or vacuum ultraviolet lamp exposure of the backing layer to enhance adhesion of adhesion layer 130 to the backing layer. Adhesion layer 130 may include adhesive material such as, for example, TRANSPIN or VALMAT (Molecular Imprints, Inc.). Other embodiments of multilayer ultra-compliant nanoimprint templates can include one or more additional layers between backing layer 128 and fluoroelastomer layer 124 and/or one or more layers 132 on top of fluoroelastomer layer 124.

A fluoroelastomer layer or nanopatterned layer of a nanoimprint lithography template can be more porous, or have a greater porosity, than the backing layer in the nanoimprint lithography template. In some cases, the porosity (or gas permeability) of the fluoroelastomer layer or nanopatterned layer of a multilayer ultra-compliant nanoimprint template is greater than the porosity of other materials used to form nanoimprint lithography templates, such as silicon, fused silica, and certain plastics, non-fluorinated polymers, and silicon-containing materials. As used herein, “porosity” refers to the ratio of the volume of all the pores in a material to the volume of the whole. A greater porosity or gas permeability of the fluoroelastomer layer advantageously enhances the escape of gas from an imprint resist through the template during an imprinting process, thus reducing the incidence of defects caused by gas pockets in the patterned layer and increasing throughput.

Generally, ultra-compliant nanoimprint templates described herein can be used to form imprints on rough surfaces, or surfaces with defects, with low, uniform residual layer thickness. A low, uniform residual layer thickness can be advantageous during subsequent etching processes by, for example, reducing feature loss that can be attributed to a thick or non-uniform residual layer.

Multilayer ultra-compliant nanoimprint template 126 can be fabricated by applying a fluoroelastomer material on backing layer 128 or adhesion layer 130, for example, by spin-coating the fluoroelastomer material or dispensing droplets of the fluoroelastomer material on the backing layer or adhesion layer. The fluoroelastomer material is contacted (e.g., in a process described with respect to FIGS. 2 and 3) with a master template, and cured with UV radiation. A thickness of fluoroelastomer layer 124 can be selected by controlling a distance between the backing layer 128 and the master template during imprinting. In some cases, the master template used to imprint the fluoroelastomer material is an etched template made of fused silica or silicon. In other cases, the master template may be a “submaster” template, formed by imprinting UV-curable resist with a master template.

The ability of a template to conform to a surface with a defect or perturbation (e.g., a particle, protrusion, or ridge) is inversely related to the exclusion radius for a given perturbation size. Typically, a template that conforms more successfully to the perturbed surface has a smaller exclusion radius. Reducing or minimizing the excluded area around a surface perturbation can be advantageous. For example, reducing or minimizing the excluded area around a surface perturbation can increase nanopattern yield over a rough substrate. As described herein, ultra-compliant templates can conform over a micron-scale defect (e.g., on the order of microns to tens of microns in diameter and up to 100 μm). In some cases, the template is operable to form a patterned layer in an imprint resist on a substrate with a micron-scale defect, such that the unpatterned area proximate the defect is less than a projected area of the defect on the substrate. Furthermore, imprinting over these micron-scale particles generally does not cause irreversible damage to the ultra-compliant template. Rather, the area of the defect region in imprints on subsequent substrates decreases, showing recovery of the ultra-compliant template.

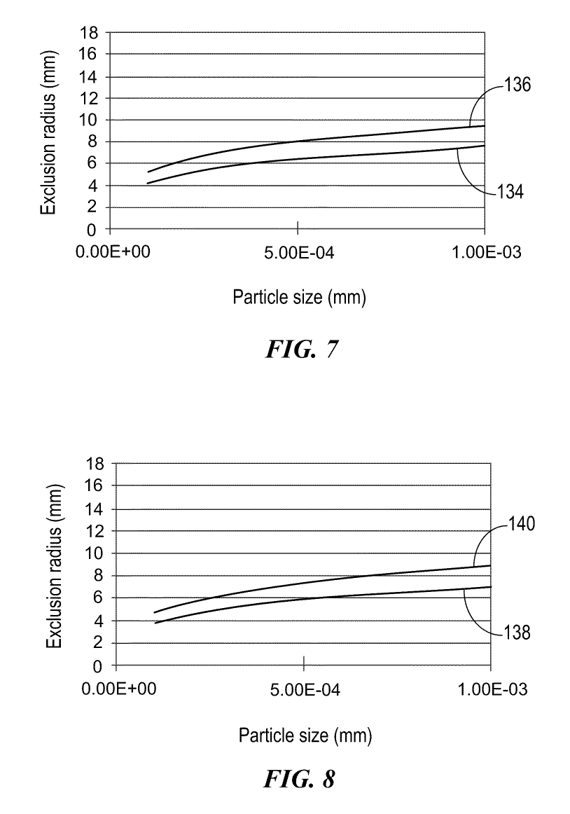

FIGS. 7 and 8 show results from mechanical calculations of bending behavior (without capillary force) to model exclusion radius versus particle size for single layer templates with a different elastic modulus. FIG. 7 shows exclusion radius versus particle size for a nanoimprint template with an elastic modulus of about 70 GPa (e.g., glass, such as standard I-1100/I-2200 template). Plots 134 and 136 refer to template thicknesses of 500 μm and 675 μm, respectively. FIG. 8 shows exclusion radius versus particle size for a nanoimprint template with an elastic modulus of about 5 GPa (e.g., CT fluoroelastomer). Plots 138 and 140 in FIG. 8 refer to template thicknesses of 500 μm and 675 μm, respectively.

As seen in FIGS. 7 and 8, templates formed with lower elastic modulus materials are expected to show reduced exclusion radius (or volume) than templates formed with higher elastic modulus materials. For example, a template with an elastic modulus of 5 MPa is expected to have an exclusion radius about an order of magnitude less than a template with an elastic modulus of 70 GPa for a particle of the same size. In addition, thinner templates are expected to show a smaller exclusion radius than thicker templates of the same material for the same particle size. This expected behavior can be extended to defects or perturbations other than particles, such as ridges and protrusions. Experimental results generally show a much lower exclusion size or radius (e.g., a factor of 1000 less) than results shown in FIGS. 7 and 8, due at least in part to the presence of other forces, such as capillary forces.

Example. A 3″ wafer that was nanoimprinted such that cured resist pillars were present on the surface served as the template (i.e., submaster template). About 1 mL of fluoroelastomer material (CT2 as shown in Table I) was dispensed on to the imprint patterned wafer (submaster template). A backing layer (with no adhesion layer) was translated to contact the fluoroelastomer material such that the fluoroelastomer material spread to expand to a larger area and to conform to the shape of the gap between the backing layer and the imprinted wafer. The gap was controlled to a thickness of 600 μm. Next, the fluoroelastomer material was cured using a broad-band UV lamp for about 10 minutes at 20 mW/cm². The backing layer was separated from the cured fluoroelastomer template, and the cured fluoroelastomer template was peeled from the imprinted wafer (submaster template) to separate the fluoroelastomer template and the imprinted wafer.

The fluoroelastomer template was then used to pattern a substrate with rough topography to test the conforming capability of the template. Imprinting was accomplished by dispensing MONOMAT (available from Molecular Imprints, Inc.) onto a substrate coated with a TRANSPIN adhesion layer (available from Molecular Imprints, Inc.) by an inkjet head and substrate stage on the IMPRIO 1100 imprint lithography system. The substrate was a high topography 6″×3.5″ substrate, with 30 μm tall, 1 mm wide ridges and surface roughness up to 600 nm over a length of 100 μm. The template was placed directly on to the dispensed array of resist droplets of resist, and pressure was applied to the backside of the template to expel trapped gas from the imprint plane. The fluoroelastomer template/resist coated substrate assembly was then translated under the z-head and exposed to UV radiation to cure the MONOMAT resist. Following UV irradiation, the fluoroelastomer template was peeled from the imprinted substrate.

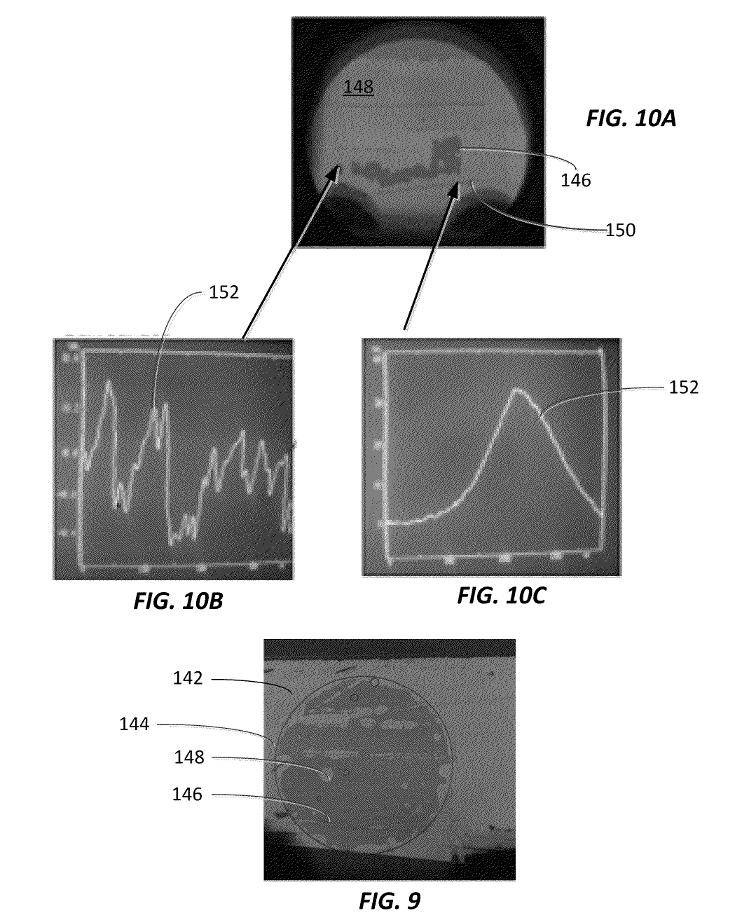

Imprinted substrate 142 is seen in FIG. 9, with imprint 144 visible as a circle. Conforming regions 144 of the imprint appear darker than non-conforming regions 146 of the imprint. As seen in FIG. 9, the imprint 144 conformed to over 75% of the imprint area.

In a comparative example, a template with an ORMOSTAMP surface (organic-inorganic silicon-containing hybrid sol gel material available from micro resist technology, GmbH, Germany) and a 600 μm thick polycarbonate backing layer (elastic modulus about 3 GPa) showed conformality over less than 25% of the imprint area, as seen in FIG. 10A. Conformality is seen by the darker color indicated by region 146 relative to the lighter, non-conforming region 148. FIGS. 10B and 10C are profilometer traces 152 of the regions indicated by arrows in FIG. 10A. FIG. 10B shows a surface texture of about 700-800 nm height variation over a 400 μm length. Ridge 150 is tens of microns tall.

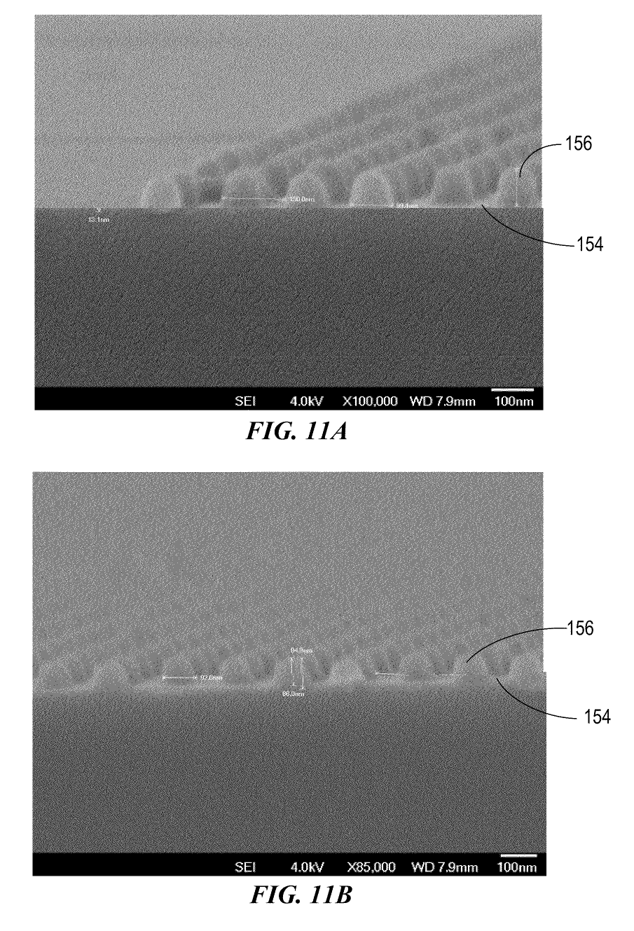

FIGS. 11A and 11B show cross-sectional SEM images of different regions (i.e., 150 nm pitch features and 160 nm pitch) of the imprint shown in FIG. 9. As shown in FIGS. 11A and 11B, the residual layer 154 between protrusions 156 had a thickness less than 15 nm for imprinted photonic crystal patterns with sub-100 nm features (150 and 160 nm pitch) on rough solar substrate. In comparison, a plastic-based template (600 μm thick with an elastic modulus about 3 GPa) conformed to less than 25% of the surface of the substrate.

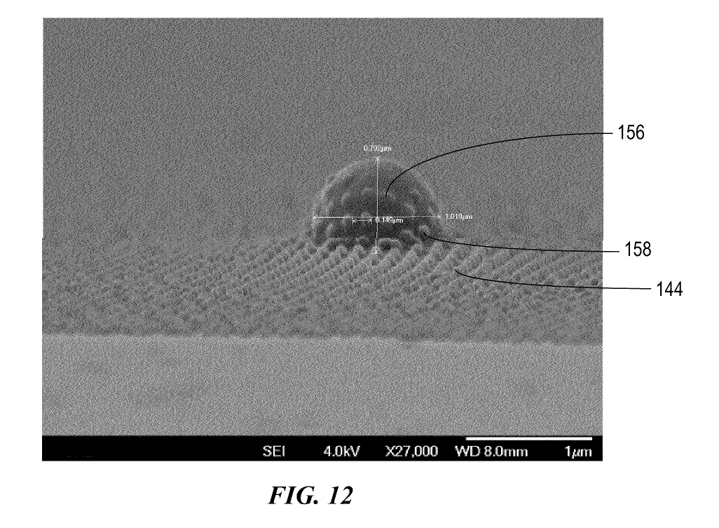

FIG. 12 shows an SEM image of imprint 144 formed with the fluoroelastomer (CT2) template around a 1 μm glass sphere 158 on a high topography substrate. As seen in FIG. 12, protrusions 156 are imprinted on particle 158, such the unpatterned area has a length is less than the diameter of glass sphere 158. The patterned layer or imprint is also seen to conform well around that particle, such that an excluded distance extends less than a diameter of the sphere from the surface of the sphere.

Further modifications and alternative embodiments of various aspects will be apparent to those skilled in the art in view of this description. Accordingly, this description is to be construed as illustrative only. It is to be understood that the forms shown and described herein are to be taken as examples of embodiments. Elements and materials may be substituted for those illustrated and described herein, parts and processes may be reversed, and certain features may be utilized independently, all as would be apparent to one skilled in the art after having the benefit of this description. Changes may be made in the elements described herein without departing from the spirit and scope as described in the following claims.

What is claimed is:

1. A nanoimprint lithography template comprising:
a backing layer; and
a nanopatterned layer adhered to the backing layer, wherein the nanopatterned layer comprises nanoscale features formed by solidifying a polymerizable material comprising a fluoroelastomer and a photoinitiator in contact with a mold,
wherein the backing layer has a higher elastic modulus than the nanopatterned layer.

2. The nanoimprint lithography template of claim 1, wherein the fluoroelastomer comprises a fluorinated ether-based acrylate, a fluorinated ether-based methacrylate, or a combination thereof.

3. The nanoimprint lithography template of claim 2, wherein the fluoroelastomer comprises a fluorinated ether-based urethane dimethacrylate, a fluorinated ether-based diacrylate, a fluorinated ether-based mono-acrylate, or a combination thereof.

4. The nanoimprint lithography template of claim 1, wherein an elastic modulus of the fluoroelastomer is between about 3 MPa and about 50 MPa.

5. The nanoimprint lithography template of claim 4, wherein the elastic modulus of the fluoroelastomer is between about 5 MPa and about 25 MPa.

6. The nanoimprint lithography template of claim 1, further comprising an adhesion layer between the backing layer and the nanopatterned layer.

7. The nanoimprint lithography template of claim 1, wherein a viscosity of the polymerizable material at room temperature is or less than about 200 cP.

8. The nanoimprint lithography template of claim 7, wherein a viscosity of the polymerizable material is less than about 150 cP.

9. The nanoimprint lithography template of claim 1, wherein the polymerizable material is ink-jettable.

10. The nanoimprint lithography template of claim 1, wherein the nanoimprint lithography template, when used to replicate the nanopatterned layer in an imprint resist on a substrate, the substrate comprising 30 μm tall, 1 mm wide ridges and surface roughness up to 600 nm over a length of 100 μm, yields an imprint that conforms to the substrate over at least 75% of the surface area of the template.

11. The nanoimprint lithography template of claim 1, wherein solidifying the polymerizable material consists of irradiating the polymerizable material with ultraviolet radiation.

12. The nanoimprint lithography template of claim 1, wherein a porosity of the nanopatterned layer is greater than a porosity of fused silica.

13. The nanoimprint lithography template of claim 1, wherein the template is operable to form a patterned layer in an imprint resist on a substrate with a micron-scale defect, such that an unpatterned area proximate the defect is less than a projected area of the defect on the substrate.

14. A nanoimprint lithography template comprising:
a backing layer; and
a nanopatterned layer adhered to the backing layer, wherein the nanopatterned layer comprises nanoscale features formed by solidifying a polymerizable material in contact with a nanopatterned mold,
wherein a viscosity of the polymerizable material at room temperature is less than about 200 cP, and the nanoimprint lithography template is operable to form a patterned layer from an imprint resist on a substrate, the substrate having a micron-scale defect, such that an unpatterned area proximate the defect is less than a projected area of the defect on the substrate.

15. The nanoimprint lithography template of claim 14, wherein the polymerizable material comprises a fluoroelastomer and a photoinitiator.

16. The nanoimprint lithography template of claim 14, wherein a porosity of the nanopatterned layer is greater than a porosity of the backing layer.

17. The nanoimprint lithography template of claim 14, wherein the nanoimprint lithography template is operable to form at least 100 imprints with no reduction in feature fidelity.

18. The nanoimprint lithography template of claim 14, wherein the nanoimprint lithography template, when used to replicate the nanopatterned layer in an imprint resist on a substrate, the substrate comprising 30 μm tall, 1 mm wide ridges and surface roughness up to 600 nm over a length of 100 μm, yields an imprint that conforms to the substrate over at least 75% of the surface area of the template.

19. A nanoimprint lithography mold assembly comprising:
a substrate;
a polymerizable material disposed on the substrate; and
a nanoimprint lithography template in contact with the polymerizable material, the nanoimprint lithography template comprising:
a backing layer; and
a nanopatterned layer adhered to the backing layer, wherein the nanopatterned layer comprises nanoscale features formed by solidifying a polymerizable material comprising a fluoroelastomer and a photoinitiator in contact with a mold, the polymerizable material having a viscosity at room temperature of less than 200 cP.

20. A method of fabricating a nanoimprint lithography template, the method comprising:
selecting a backing layer;
disposing a polymerizable material on the backing layer, the polymerizable material comprising a fluoroelastomer and a photoinitiator and having a viscosity at room temperature of less than about 200 cP;
contacting the polymerizable material with a nanopatterned mold;
exposing the polymerizable material to ultraviolet radiation to solidify the polymerizable material, thereby forming a solidified nanopatterned layer in contact with the nanopatterned mold and adhered to the backing layer, wherein an elastic modulus of the solidified nanopatterned layer is greater than an elastic modulus of the backing layer; and
separating the nanopatterned mold from the solidified nanopatterned layer adhered to the substrate.
